(19) United States
(12) Patent Application Publication
(10) Pub. No.: US 2025/0259335 A1
(43) Pub. Date: Aug. 14, 2025

(54) WAVELET CODING AND DECODING OF DYNAMIC MESHES BASED ON VIDEO COMPONENTS AND METADATA

(71) Applicant: Nokia Technologies Oy, Espoo (FI)

(72) Inventors: Patrice RONDAO ALFACE, Antwerp (BE); Sebastian SCHWARZ, Munich (DE); Aleksei MARTEMIANOV, Tampere (FI); Lukasz KONDRAD, Munich (DE); Lauri Aleksi ILOLA, Tampere (FI)

(21) Appl. No.: 18/857,020

(22) PCT Filed: Apr. 4, 2023
(86) PCT No.: PCT/IB2023/053438

§ 371 Date: Oct. 15, 2024

Related U.S. Application Data
(60) Provisional application No. 63/333,167, filed on Apr. 21, 2022.

(51) Int. Cl. G06T 9/00

(52) U.S. Cl. CPC G06T 9/001

(57) ABSTRACT

An apparatus including at least one processor; and at least one memory including computer program code. The at least one memory and the computer program code are configured to, with the at least one processor, cause the apparatus at least to: decode, for a frame of three-dimensional object data, a base mesh of the three-dimensional object data, wherein the base mesh has been generated with a geometry component; and decode, for the frame, a displacement field, where the displacement field comprises wavelet encoded and quantized position displacements.

### TECHNICAL FIELD

The examples and non-limiting embodiments relate generally to volumetric video, and more particularly, to mesh coding.

### BACKGROUND

It is known to perform encoding and decoding of images and video.

### SUMMARY

The following summary is merely intended to be an example. The summary is not intended to limit the scope of the claims.

In accordance with one aspect, an example apparatus is provided comprising: at least one processor; and at least one memory including computer program code; wherein the at least one memory and the computer program code are configured to, with the at least one processor, cause the apparatus at least to: decode, for a frame of three-dimensional object data, a base mesh of the three-dimensional object data, wherein the base mesh has been generated with a geometry component; and decode, for the frame, a displacement field, where the displacement field comprises wavelet encoded and quantized position displacements.

In accordance with another aspect, an example method may be provided comprising: decoding, for a frame of three-dimensional object data, a base mesh of the three-dimensional object data, wherein the base mesh has been generated with a geometry component; and decoding, for the frame, a displacement field, where the displacement field comprises wavelet encoded and quantized position displacements.

In accordance with another aspect, an example embodiment may be provided comprising a non-transitory program storage device readable by a machine, tangibly embodying a program of instructions executable by the machine for performing operations, the operations comprising: decoding, for a frame of three-dimensional object data, a base mesh of the three-dimensional object data, wherein the base mesh has been generated with a geometry component; decoding, for the frame, a displacement field, where the displacement field comprises wavelet encoded and quantized position displacements.

In accordance with another aspect, an example apparatus may be provided comprising: means for decoding, for a frame of three-dimensional object data, a base mesh of the three-dimensional object data, wherein the base mesh has been generated with a geometry component; and means for decoding, for the frame, a displacement field, where the displacement field comprises wavelet encoded and quantized position displacements.

In accordance with another aspect, an example apparatus may be provided comprising: at least one processor; and at least one memory including computer program code; wherein the at least one memory and the computer program code are configured to, with the at least one processor, cause the apparatus at least to: decode, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example method may be provided comprising: decoding, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example embodiment may be provided comprising a non-transitory program storage device readable by a machine, tangibly embodying a program of instructions executable by the machine for performing operations, the operations comprising: decoding, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example embodiment may be provided in an apparatus comprising: means for decoding, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example embodiment may be provided with an apparatus comprising: at least one processor; and at least one memory including computer program code; wherein the at least one memory and the computer program code are configured to, with the at least one processor, cause the apparatus at least to: based upon input meshes, for a frame of three-dimensional object data, where the input meshes comprise a mesh file and a material file, generate: a base mesh of the three-dimensional object data, wherein the base mesh is generated with geometry and occupancy components; and a displacement field, where the displacement field comprises wavelet encoded and quantized position displacements.

In accordance with another aspect, an example method may be provided comprising: based upon input meshes, for a frame of three-dimensional object data, where the input meshes comprise a mesh file and a material file, generating: a base mesh of the three-dimensional object data, wherein the base mesh is generated with geometry and occupancy components; a displacement field, where the displacement field comprises wavelet encoded and quantized position displacements.

In accordance with another aspect, an example embodiment may be provided with a non-transitory program storage device readable by a machine, tangibly embodying a program of instructions executable by the machine for performing operations, the operations comprising: based upon input meshes, for a frame of three-dimensional object data, where the input meshes comprise a mesh file and a material file, generating: a base mesh of the three-dimensional object data, wherein the base mesh is generated with geometry and occupancy components; and a displacement field, where the displacement field comprises wavelet encoded and quantized position displacements.

In accordance with another aspect, an example embodiment may be provided in an apparatus comprising: means for, based upon input meshes, for a frame of three-dimensional object data, where the input meshes comprise a mesh file and a material file, generating: a base mesh of the three-dimensional object data, wherein the base mesh is generated with geometry and occupancy components; and a displacement field, where the displacement field comprises wavelet encoded and quantized position displacements.

In accordance with another aspect, an example embodiment may be provided with an apparatus comprising: at least one processor; and at least one memory including computer program code; wherein the at least one memory and the computer program code are configured to, with the at least one processor, cause the apparatus at least to: based upon input meshes, for a frame of three-dimensional object data, where the input meshes comprise a mesh file, a material file and a texture file, generate: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example method may be provided comprising: based upon input meshes, for a frame of three-dimensional object data, where the input meshes comprise a mesh file, a material file and a texture file, generating: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example embodiment may be provided with a non-transitory program storage device readable by a machine, tangibly embodying a program of instructions executable by the machine for performing operations, the operations comprising: based upon input meshes, for a frame of three-dimensional object data, where the input meshes comprise a mesh file, a material file and a texture file, generating: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example embodiment may be provided with an apparatus comprising: means for, based upon input meshes, for a frame of three-dimensional object data, where the input meshes comprise a mesh file, a material file and a texture file, generating: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements.

In accordance with another aspect, an example embodiment may be provided with an apparatus comprising: at least one processor; and at least one memory including computer program code; wherein the at least one memory and the computer program code are configured to, with the at least one processor, cause the apparatus at least to: signal within a bitstream a flag indicating the presence of a mesh encoding relating to metadata of three-dimensional object data, where the flag is configured to signal geometry and occupancy data and displacement field data in a single video component.

In accordance with another aspect, an example method may be provided comprising: signaling within a bitstream a flag indicating the presence of a mesh encoding relating to metadata of three-dimensional object data, where the flag is configured to signal geometry and occupancy data and displacement field data in a single video component.

In accordance with another aspect, an example embodiment may be provided with a non-transitory program storage device readable by a machine, tangibly embodying a program of instructions executable by the machine for performing operations, the operations comprising: signaling within a bitstream a flag indicating the presence of a mesh encoding relating to metadata of three-dimensional object data, where the flag is configured to signal geometry and occupancy data and displacement field data in a single video component.

In accordance with another aspect, an example embodiment may be provided with an apparatus comprising: means for signaling within a bitstream a flag indicating the presence of a mesh encoding relating to metadata of three-dimensional object data, where the flag is configured to signal geometry and occupancy data and displacement field data in a single video component.

### BRIEF DESCRIPTION OF THE DRAWINGS

The foregoing aspects and other features are explained in the following description, taken in connection with the accompanying drawings, wherein:

FIG. 1A is a diagram showing volumetric media conversion at an encoder side.

FIG. 1B is a diagram showing volumetric media reconstruction at a decoder side.

FIG. 2 shows an example of block to patch mapping.

FIG. 3A shows an example of an atlas coordinate system.

FIG. 3B shows an example of a local 3D patch coordinate system.

FIG. 3C shows an example of a final target 3D coordinate system.

FIG. 4 shows elements of a mesh.

FIG. 5 shows an example V-PCC extension for mesh encoding, based on the embodiments described herein.

FIG. 6 shows an example V-PCC extension for mesh decoding, based on the embodiments described herein.

FIG. 7 is a diagram illustrating an example of a decoder;

FIG. 8 is a diagram illustrating an example of a decoder;

FIG. 9 is a diagram illustrating an example of an encoder;

FIG. 10 is a diagram illustrating an example of a decoder;

FIG. 11 is a diagram illustrating an example of a base mesh generation;

FIG. 12 is a diagram illustrating an example of encoding of base meshes;

FIG. 13 is a diagram illustrating an example of a full mesh encoder;

FIG. 14 is a diagram illustrating an example of a full mesh encoder with geometry, occupancy and displacement field;

FIG. 15 is a diagram illustrating an example of a mesh encoder with attribute map recomputed after wavelet transform;

FIG. 16 is a diagram illustrating an example of a V3C signaling;

FIG. 17 is a diagram illustrating some components of example embodiments;

FIG. 18 is a diagram illustrating an example of one type of method;

FIG. 19 is a diagram illustrating an example of one type of method;

FIG. 20 is a diagram illustrating an example of one type of method.

### DETAILED DESCRIPTION OF EXAMPLE EMBODIMENTS

The examples described herein relate to the encoding, signaling and rendering of a volumetric video that is based on mesh coding. The examples described herein focus on methods improving the quality of reconstructed mesh surfaces. The examples described herein relate to methods to improve quality of decoded mesh textures and geometry by using its hierarchical representation which as a consequence increases compression efficiency of the encoding pipeline.

### Volumetric Video Data

Volumetric video data represents a three-dimensional scene or object and can be used as input for AR, VR and MR applications. Such data describes geometry (shape, size, position in 3D-space) and respective attributes (e.g. color, opacity, reflectance, . . . ), plus any possible temporal transformations of the geometry and attributes at given time instances (like frames in 2D video). Volumetric video is either generated from 3D models, i.e. CGI, or captured from real-world scenes using a variety of capture solutions, e.g. multi-camera, laser scan, combination of video and dedicated depth sensors, and more. Also, a combination of CGI and real-world data is possible. Typical representation formats for such volumetric data are triangle meshes, point clouds, or voxels. Temporal information about the scene can be included in the form of individual capture instances, i.e. “frames” in 2D video, or other means, e.g. position of an object as a function of time.

Because volumetric video describes a 3D scene (or object), such data can be viewed from any viewpoint. Therefore, volumetric video is an important format for AR, VR, or MR applications, especially for providing 6DOF viewing capabilities.

Increasing computational resources and advances in 3D data acquisition devices have enabled reconstruction of highly detailed volumetric video representations of natural scenes. Infrared, lasers, time-of-flight and structured light are all examples of devices that can be used to construct 3D video data. Representation of the 3D data depends on how the 3D data is used. Dense voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding this 3D data as a set of textures and a depth map as is the case in the multi-view plus depth framework. Closely related to the techniques used in multi-view plus depth is the use of elevation maps, and multi-level surface maps.

### MPEG Visual Volumetric Video-Based Coding (V3C)

Selected excerpts from the ISO/IEC 23090-5 Visual Volumetric Video-based Coding and Video-based Point Cloud Compression 2nd Edition standard are referred to herein.

Visual volumetric video, a sequence of visual volumetric frames, if uncompressed, may be represented by a large amount of data, which can be costly in terms of storage and transmission. This has led to the need for a high coding efficiency standard for the compression of visual volumetric data.

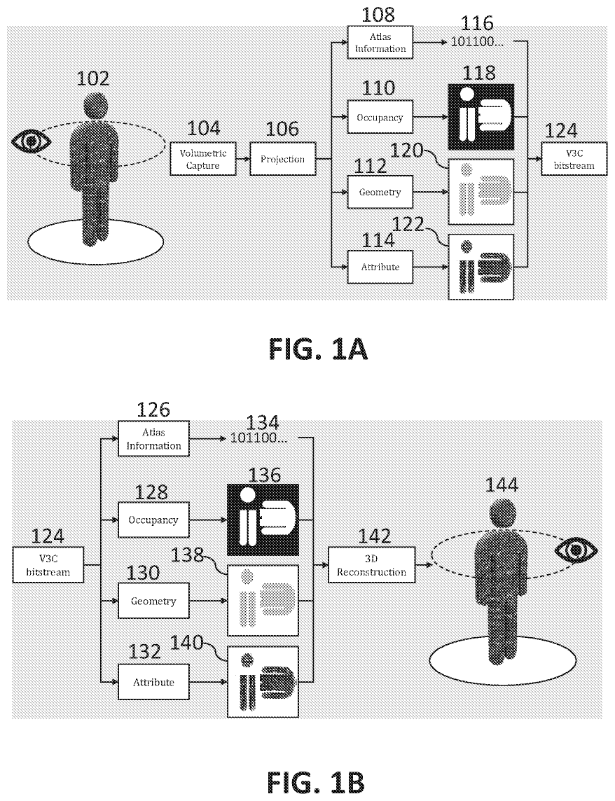

The V3C specification enables the encoding and decoding processes of a variety of volumetric media by using video and image coding technologies. This is achieved through first a conversion of such media from their corresponding 3D representation to multiple 2D representations, also referred to as V3C components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g. texture or material information, of such 3D data. An example is shown in FIG. 1A and FIG. 1B.

FIG. 1A shows volumetric media conversion at the encoder, and FIG. 1B shows volumetric media conversion at the decoder side. The 3D media 102 is converted to a series of 2D representations: occupancy 118, geometry 120, and attribute 122. Additional atlas information 108 is also included in the bitstream to enable inverse reconstruction. Refer to ISO/IEC 23090-5.

As further shown in FIG. 1A, a volumetric capture operation 104 generates a projection 106 from the input 3D media 102. In some examples, the projection 106 is a projection operation. From the projection 106, an occupancy operation 110 generates the occupancy 2D representation 118, a geometry operation 112 generates the geometry 2D representation 120, and an attribute operation 114 generates the attribute 2D representation 122. The additional atlas information 108 is included in the bitstream 116. The atlas information 108, the occupancy 2D representation 118, the geometry 2D representation 120, and the attribute 2D representation 122 are encoded into the V3C bitstream 124 to encode a compressed version of the 3D media 102.

As shown in FIG. 1B, a decoder using the V3C bitstream 124 derives 2D representations using an occupancy operation 128, a geometry operation 130 and an attribute operation 132. The atlas information operation 126 provides atlas information into a bitstream 134. The occupancy operation 128 derives the occupancy 2D representation 136, the geometry operation 130 derives the geometry 2D representation 138, and the attribute operation 132 derives the attribute 2D representation 140. The 3D reconstruction operation 142 generates a decompressed reconstruction 144 of the 3D media 102, using the atlas information 126/134, the occupancy 2D representation 136, the geometry 2D representation 138, and the attribute 2D representation 140.

Additional information that allows associating all these subcomponents and enables the inverse reconstruction, from a 2D representation back to a 3D representation is also included in a special component, referred to herein as the atlas. An atlas consists of multiple elements, namely patches. Each patch identifies a region in all available 2D components and contains information necessary to perform the appropriate inverse projection of this region back to the 3D space. The shape of such regions is determined through a 2D bounding box associated with each patch as well as their coding order. The shape of these regions is also further refined after the consideration of the occupancy information.

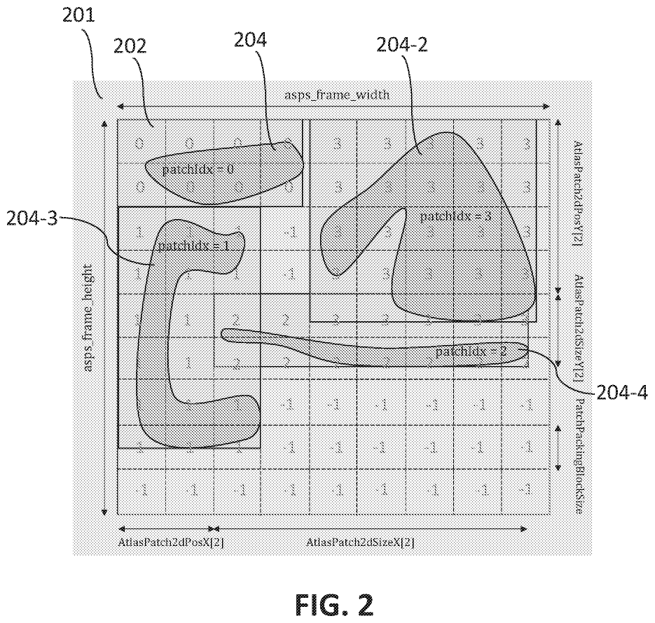

Atlases are partitioned into patch packing blocks of equal size. Refer for example to block 202 in FIG. 2, where FIG. 2 shows an example of block to patch mapping. The 2D bounding boxes of patches and their coding order determine the mapping between the blocks of the atlas image and the patch indices. FIG. 2 shows an example of block to patch mapping with 4 projected patches (204, 204-2, 204-3, 204-4) onto an atlas 201 when asps_patch_precedence_order_flag is equal to 0. Projected points are represented with dark gray. The area that does not contain any projected points is represented with light grey. Patch packing blocks 202 are represented with dashed lines. The number inside each patch packing block 202 represents the patch index of the patch (204, 204-2, 204-3, 204-4) to which it is mapped.

Axes orientations are specified for internal operations. For instance, the origin of the atlas coordinates is located on the top-left corner of the atlas frame. For the reconstruction step, an intermediate axes definition for a local 3D patch coordinate system is used. The 3D local patch coordinate system is then converted to the final target 3D coordinate system using appropriate transformation steps.

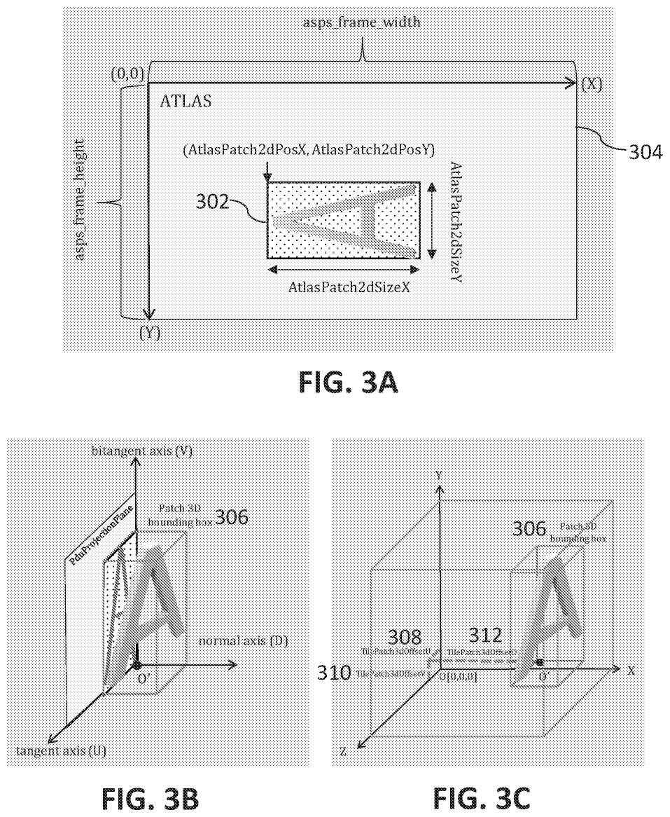

FIG. 3A shows an example of an atlas coordinate system, FIG. 3B shows an example of a local 3D patch coordinate system, and FIG. 3C shows an example of a final target 3D coordinate system. Refer to ISO/IEC 23090-5.

FIG. 3A shows an example of a single patch 302 packed onto an atlas image 304. This patch 302 is then converted, with reference to FIG. 3B, to a local 3D patch coordinate system (U, V, D) defined by the projection plane with origin O′, tangent (U), bi-tangent (V), and normal (D) axes. For an orthographic projection, the projection plane is equal to the sides of an axis-aligned 3D bounding box 306, as shown in FIG. 3B. The location of the bounding box 306 in the 3D model coordinate system, defined by a left-handed system with axes (X, Y, Z), can be obtained by adding offsets TilePatch3dOffsetU 308, TilePatch3DOffsetV 310, and TilePatch3DOffsetD 312, as illustrated in FIG. 3C.

### V3C High Level Syntax

Coded V3C video components are referred to herein as video bitstreams, while an atlas component is referred to as the atlas bitstream. Video bitstreams and atlas bitstreams may be further split into smaller units, referred to herein as video and atlas sub-bitstreams, respectively, and may be interleaved together, after the addition of appropriate delimiters, to construct a V3C bitstream.

V3C patch information is contained in an atlas bitstream, atlas_sub_bitstream( ), which contains a sequence of NAL units. A NAL unit is specified to format data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex D of ISO/IEC 23090-5 each NAL unit can be preceded by an additional element that specifies the size of the NAL unit.

NAL units in an atlas bitstream can be divided into atlas coding layer (ACL) and non-atlas coding layer (non-ACL) units. The former is dedicated to carry patch data, while the latter is dedicated to carry data necessary to properly parse the ACL units or any additional auxiliary data.

In the nal_unit_header( ) syntax nal_unit_type specifies the type of the RBSP data structure contained in the NAL unit as specified in Table 4 of ISO/IEC 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of ISO/IEC 23090-5 shall ignore (i.e., remove from the bitstream and discard) all NAL units with values of nal_layer_id not equal to 0.

### V3C Extension Mechanisms

While designing the V3C specification it was envisaged that amendments or new editions can be created in the future. In order to ensure that the first implementations of V3C decoders are compatible with any future extension, a number of fields for future extensions to parameter sets were reserved.

For example, the second edition of V3C introduced extensions in VPS related to MIV and the packed video component.

| | |
|---|---|
| . . . | |
| vps_extension_present_flag | u(1) |
| if( vps_extension_present_flag ) { | |
| vps_packing_information_present_flag | u(1) |
| vps_miv_extension_present_flag | u(1) |
| vps_extension_6bits | u(6) |
| } | |
| if( vps_packing_information_present_flag ) { | |
| for( k = 0 ; k <= vps_atlas_count_minus1; k++ ) { | |
| j = vps_atlas_id[ k ] | |
| vps_packed_video_present_flag[ j ] | |
| if( vps_packed_video_present_flag[ j ] ) | |
| packing_information( j ) | |
| } | |
| } | |
| if( vps_miv_extension_present_flag ) | |
| vps_miv_extension( ) /*Specified in ISO/IEC 23090-12 (Under | |
| preparation. Stage at time of publication: ISO/IEC FDIS 23090-12:2022)*/ | |
| if( vps_extension_6bits ) { | |
| vps_extension_length_minus1 | ue(v) |
| for( j = 0; j < vps_extension_length_minus1 + 1; j++ ) { | |
| vps_extension_data_byte | u(8) |
| } | |
| } | |
| byte_alignment( ) | |
| } | |

### Rendering and Meshes

A polygon mesh is a collection of vertices, edges and faces that defines the shape of a polyhedral object in 3D computer graphics and solid modeling. The faces usually consist of triangles (triangle mesh), quadrilaterals (quads), or other simple convex polygons (n-gons), since this simplifies rendering, but may also be more generally composed of concave polygons, or even polygons with holes.

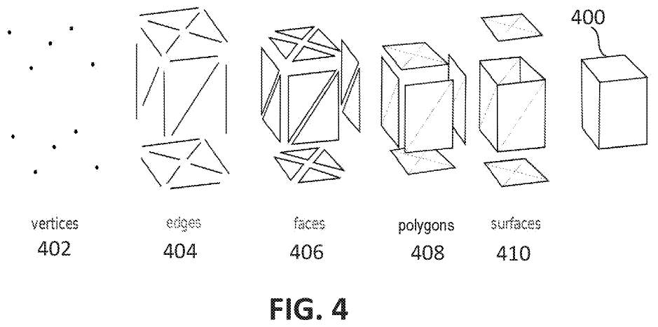

With reference to FIG. 4, objects 400 created with polygon meshes are represented by different types of elements. These include vertices 402, edges 404, faces 406, polygons 408 and surfaces 410 as shown in FIG. 4. Thus, FIG. 4 illustrates elements of a mesh.

Polygon meshes are defined by the following elements:

Vertex (402): a position in 3D space defined as (x, y, z) along with other information such as color (r, g, b), normal vector and texture coordinates.

Edge (404): a connection between two vertices.

Face (406): a closed set of edges 404, in which a triangle face has three edges, and a quad face has four edges. A polygon 408 is a coplanar set of faces 406. In systems that support multi-sided faces, polygons and faces are equivalent. Mathematically a polygonal mesh may be considered an unstructured grid, or undirected graph, with additional properties of geometry, shape and topology.

Surfaces (410): or smoothing groups, are useful, but not required to group smooth regions.

Groups: some mesh formats contain groups, which define separate elements of the mesh, and are useful for determining separate sub-objects for skeletal animation or separate actors for non-skeletal animation.

Materials: defined to allow different portions of the mesh to use different shaders when rendered.

UV coordinates: most mesh formats also support some form of UV coordinates which are a separate 2D representation of the mesh “unfolded” to show what portion of a 2-dimensional texture map to apply to different polygons of the mesh. It is also possible for meshes to contain other such vertex attribute information such as color, tangent vectors, weight maps to control animation, etc. (sometimes also called channels).

### V-PCC Mesh Coding Extension (MPEG M49588)

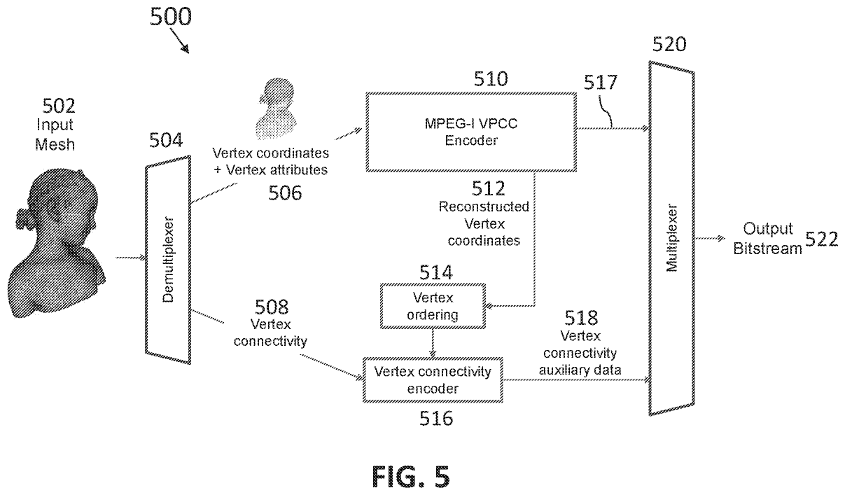

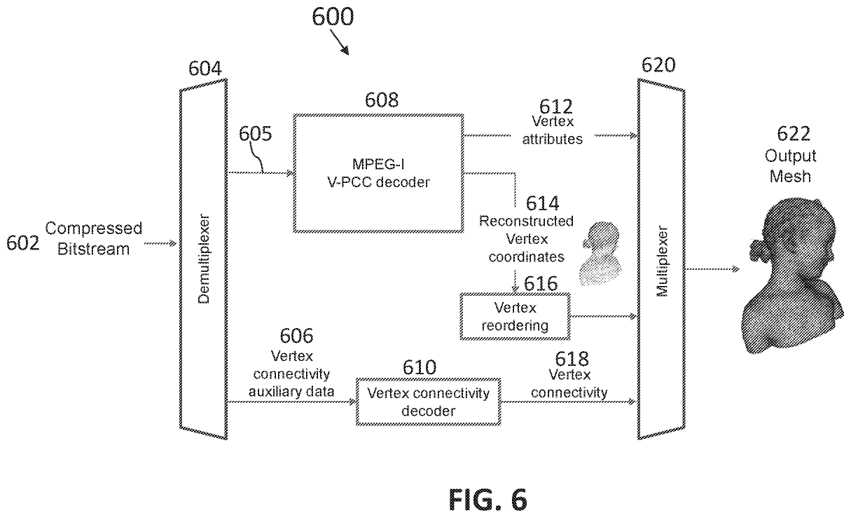

FIG. 5 and FIG. 6 show the extensions to the V-PCC encoder and decoder to support mesh encoding and mesh decoding, respectively, as proposed in MPEG input document [MPEG M47608].

In the encoder extension 500, the input mesh data 502 is demultiplexed with demultiplexer 504 into vertex coordinates+attributes 506 and vertex connectivity 508. The vertex coordinates+attributes data 506 is coded using MPEG-I V-PCC (such as with MPEG-I VPCC encoder 510), whereas the vertex connectivity data 508 is coded (using vertex connectivity encoder 516) as auxiliary data 518. Both of these (encoded vertex coordinates and vertex attributes 517 and auxiliary data 518) are multiplexed using multiplexer 520 to create the final compressed output bitstream 522. Vertex ordering 514 is carried out on the reconstructed vertex coordinates 512 at the output of MPEG-I V-PCC 510 to reorder the vertices for optimal vertex connectivity encoding 516.

As shown in FIG. 6, in the decoder 600, the input bitstream 602 is demultiplexed with demultiplexer 604 to generate the compressed bitstreams for vertex coordinates+attributes 605 and vertex connectivity 606. The input/compressed bitstream 602 may comprise or may be the output from the encoder 500, namely the output bitstream 522 of FIG. 5. The vertex coordinates+attributes data 605 is decompressed using MPEG-I V-PCC decoder 608 to generate vertex attributes 612. Vertex ordering 616 is carried out on the reconstructed vertex coordinates 614 at the output of MPEG-I V-PCC decoder 608 to match the vertex order at the encoder 500. The vertex connectivity data 606 is also decompressed using vertex connectivity decoder 610 to generate vertex connectivity information 618, and everything (including vertex attributes 612, the output of vertex reordering 616, and vertex connectivity information 618) is multiplexed with multiplexer 620 to generate the reconstructed mesh 622.

### Generic Mesh Compression

Mesh data may be compressed directly without projecting it into 2D-planes, like in V-PCC based mesh coding. In fact, the anchor for V-PCC mesh compression call for proposals (CfP) utilizes off-the shelf mesh compression technology, Draco (https://google.github.io/draco/), for compressing mesh data excluding textures. Draco is used to compress vertex positions in 3D, connectivity data (faces) as well as UV coordinates. Additional per-vertex attributes may be also compressed using Draco. The actual UV texture may be compressed using traditional video compression technologies, such as H.265 or H.264.

Draco uses the edgebreaker algorithm at its core to compress 3D mesh information. Draco offers a good balance between simplicity and efficiency, and is part of Khronos endorsed extensions for the glTF specification. The main idea of the algorithm is to traverse mesh triangles in a deterministic way so that each new triangle is encoded next to an already encoded triangle. This enables prediction of vertex specific information from the previously encoded data by simply adding delta to the previous data. Edgebreaker utilizes symbols to signal how each new triangle is connected to the previously encoded part of the mesh. Connecting triangles in such a way results on average in 1 to 2 bits per triangle when combined with existing binary encoding techniques.

MPEG 3DG (ISO/IEC SC29 WG7) has issued a call for proposal (CfP) on integration of MESH compression into the V3C family of standards (ISO/IEC 23090-5). We have identified that relying on video-coding only approaches would enable the hardware support of most client devices that can run applications consuming dynamic mesh content. Mesh codecs such as Draco are not international standards and are not supported by hardware implementations; only CPU-based software is available.

This can be an issue for running dynamic mesh decoding with low latency and the required real-time constraints.

Hybrid approaches relying on a software-based mesh codec such as Draco and a video-based approach may involve important CPU-GPU communication, slowing down performance and increasing latency.

It may be important to be able to extract, at very low processing cost, a small resolution Level-of-Detail (LOD) from an encoded mesh bitstream, particularly when an application renders several dynamic meshes at different rendering distances.

Hardware support for video decoding is already important for mobile devices and can support a multitude of video streams at high resolution (e.g., for HEVC encoded streams, one 4K stream at 60 Hz, or four 1080p at 60 Hz, or twice as much at 30 Hz) and bit depths (e.g. 10 bits). We, therefore, foresee that CPU-based software approaches (e.g. Draco-based) to decode base meshes are more likely to become a bottleneck for immersive applications, than hardware-accelerated video-based approaches, and may cause stuttering. For a video-based approach, an feature is deployability: A codec that is mostly supported by hardware video decoding with some extra metadata, such as a pure video-based approach, has also more chances to be widely deployed on end-devices than hybrid approaches that require significant software implementation efforts.

Previously, the state of the art in video-based compression has been advanced with the responses made to the Dynamic Mesh compression CfP organized by MPEG 3DG (ISO/IEC SC29 WG7) such as the following.

### Pure Video-Based Mesh Compression

Two approaches are based on video-based mesh compression only, leveraging on V-PCC to encode meshes. This includes Nokia's response to CfP for Dynamic Mesh compression, ISO/IEC JTC 1/SC 29/WG 7 m59274, Online, April 2022 by Patrice Rondao Alface, Aleksei Martemianov, Sebastian Schwarz, Lauri Ilola, Lukasz Kondrad, Jozsef Szabo, Christoph Bachhuber (hereinafter [Ron22]); and Tencent's Dynamic Mesh Coding CfP response, ISO/IEC JTC 1/SC 29/WG 7 m59295, Online, April 2022 by Xiang Zhang, Chao Huang, Jun Tian, Xiaozhong Xu, Shan Liu, (hereinafter [Zha22]). While [Ron22] focuses on encoding mesh geometry as V3C geometry and occupancy components, [Zha22] encode patch vertex contours to avoid an explicit encoding of occupancy. Vertex Contours coding require specific prediction and entropy coding that are not supported by video hardware encoding and decoding.

### Video-Based Mesh Compression Using a Mesh Codec

This is described in Sony's Dynamic Mesh Coding Call for Proposal Response, ISO/IEC JTC 1/SC 29/WG 7 m59284, Online, April 2022 by Danillo B. Graziosi, Satoru Kuma, Kao Hayashi, Ohji Nakagami, Ali Tabatabai, (hereinafter [Gra22]). In [Gra22] mesh connectivity is encoded using EdgeBreaker based on Draco's implementation, while texture and geometry are encoded similarly as in [Ron22] and [Zha22].

### Wavelet-Based Mesh Compression Using a Mesh Codec

This is described in [V-CG] Apple's Dynamic Mesh Coding CfP Response, ISO/IEC JTC 1/SC 29/WG 7 m59281, Online, April 2022, by Khaled Mammou, Jungsun Kim, Alexis Tourapis, Dimitri Podborski, (hereinafter [Mam22]). A wavelet-based approach was used in [Mam22] that relies on a base mesh (smallest LOD) and uses a subdivision scheme and displacement vectors that are hierarchically encoded with a lazy wavelet transform. Displacement vectors are quantized and packed in a video component, texture is mapped to a video component and the base mesh is encoded, including its geometry, with Draco.

### Intra-Only, Remeshing-Based Compression Using a Mesh Codec

This is described in InterDigital's Response to Dynamic Mesh Coding CfP, ISO/IEC JTC 1/SC 29/WG 7 m 59285, Online, April 2022, by Jean-Eudes Marvie, Celine Guede, Julien Ricard, Olivier Mocquard, Maja Krivokuda, Frangois-Louis Tariolle, (hereinafter [Mar22]). In [Mar22], a base-mesh is also used as in [Mam22] and encoded with Draco, while geometry and texture are encoded as video components as in [Ron22, Zha22, Gra22].

In terms of objective metrics, purely video-based approaches [Ron22, Zha22] have performed better than the Draco encoded anchor only at low and medium bitrates, while the approaches using Draco to encode connectivity or a base mesh such as [Mam22, Mar22] have outperformed the anchor at almost all rates. However, in line with the problem noted above, the only approaches that could scale with the number of streams on mobile client devices are the purely video-based ones.

Features as described herein may be used in regard to a non-obvious combination of:
a wavelet-based coding approach and
a purely video-based approach,
avoiding any use of Draco or a similar mesh codec such that:
complexity and scalability is similar to the purely video-based approaches
compression performance is similar to the wavelet-based approach using Draco

Instead of using a mesh codec to compress a base mesh, a purely video based approach may be extended to enable the decoding of a base mesh. Care may be taken to re-use as much as possible video components for decoding the mesh representation: the attribute video component does not need to be repeated, and all geometry-related information can be packed in one or two video component (s).

Using three video components enables to extract the base mesh with the lowest possible processing complexity; skipping all un-necessary decoding and rendering steps of the full mesh. However, it may use three parallel decoding sessions for generating the full mesh when it has to be decoded.

Packing geometry-related data together enables to reduce the number of parallel decoding sessions for generating the full mesh. However, when it comes to only extracting the base mesh scenario, it may decode a larger video component than in the two geometry-related video components case. Moreover, signaling a video component filled with quantized wavelet transform coefficients may be done by extending V3C Attributes types and be more optimal than coding those as geometry data.

### Decoding Embodiments

### 1) Three Video Components

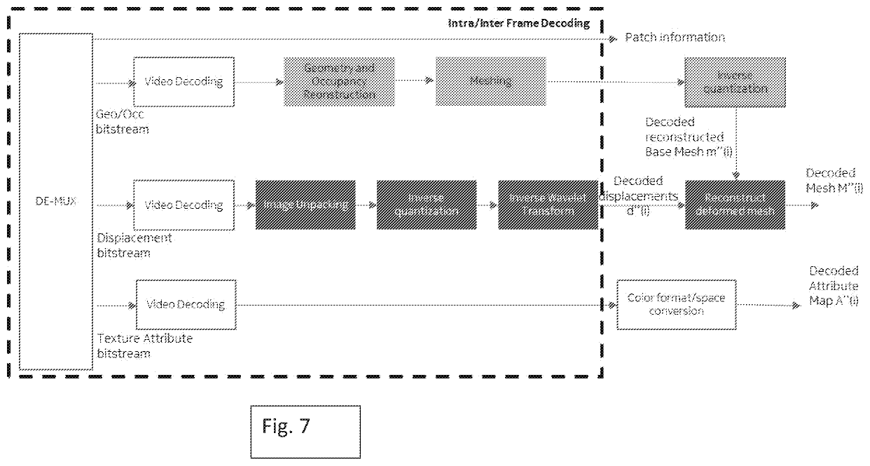

In one example embodiment, with reference to FIG. 7 which is shown in regard to a decoder using three video components, the mesh representation (per frame) consists in three Video Components that are all independently encoded using a video codec such as HEVC or VVC:
A base mesh bitstream that is encoded with a Video Component where Geometry and Occupancy. In one type of example embodiment, the base mesh may be generated with geometry and, optionally with occupancy component. This covers cases where occupancy may not be used or may be bypassed.
A displacement field bitstream that contains wavelet encoded and quantized position displacements or error vectors
An attribute bitstream containing texture information.

Metadata is also included in the representation as an extension of the V3C syntax.

This metadata describes:
the information required to decode the base mesh,
the information required to perform the inverse quantization, inverse wavelet transform and subdivision scheme used to apply decoded displacements (for example represented by a new V3C Transform Attribute type) on the decoded base mesh
the information required to convert the Texture Attribute Map to the desired color format/space

Furthermore, this embodiment enables to extract the base mesh without decoding and reconstructing the full mesh if required.

If the Texture Attribute Map is not decoded, only the geometry of the base mesh may be provided.

In another example embodiment, the Attribute Map Video Component resolution and the Displacement fields Video Component resolution are set at a resolution that is obtained by scaling the Base Mesh Geometry+Occupancy Video Component resolution. The scaling factor is signaled in the V3C metadata and is used in the base mesh reconstruction process to obtain the UV coordinates in the Attribute Map.

In another example embodiment, the Texture Attribute map data relative to the base mesh vertices is packed within a tile of the Geometry+Occupancy Video Component. The fact this process is used can be flagged in the V3C bitstream by setting the flag base_mesh_attribute_data_packed_in_geometry_flag to true as well as the V3C packing information metadata. The base mesh attribute data can be encoded in RAW patches for example. This may cause compression penalty, but is limited to the base mesh resolution, which is small and enables to decode the base mesh with a single video decoder.

### Decoding Embodiments

### 2) Two Video Components

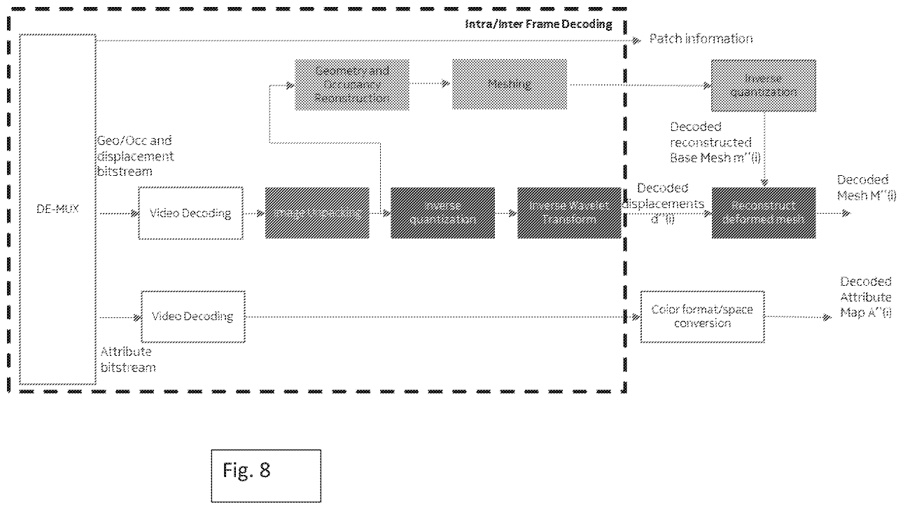

In one example embodiment, with reference to FIG. 8 which is shown in regard to a decoder using two video components, the mesh representation (per frame) consists in two Video Components that are independently encoded using a video codec such as HEVC or VVC:
A Video Component consisting in the packing of:
   Geometry and Occupancy that are used for decoding a base mesh
   A displacement field that contains wavelet encoded and quantized position displacements or error vectors
An attribute bitstream containing texture information.

Metadata is also included in the representation as an extension of the V3C syntax.

This metadata describes:
the information required to unpack the Video Component containing both
   the base mesh Geometry and Occupancy
   optionally the base mesh Attribute Map data
   the displacement field data
the information required to decode and reconstruct the base mesh with or without attributes.
the information required to perform the inverse quantization, inverse wavelet transform and subdivision scheme used to apply decoded displacements on the decoded base mesh
the information required to convert the Attribute Map to the desired color format/space

Furthermore, this example embodiment enables to extract the base mesh without decoding and reconstructing the full mesh if required. This may decode the Video Component where the Geometry and Occupancy, as well as the displacement field data is packed, but may skip the reconstruction of the full displaced mesh.

If the Texture Attribute Map is not decoded, only the geometry of the base mesh might be provided.

In another example embodiment, the Texture Attribute Map Video Component resolution and the Displacement fields Video Component resolution are set a resolution that is obtained by scaling the Base Mesh Geometry+Occupancy Video Component resolution. The scaling factor may be flagged in the V3C metadata and used in the base mesh reconstruction process to obtain the UV coordinates in the Attribute Map.

In another embodiment, the Attribute map data relative to the base mesh vertices is packed within a tile of the Geometry+Occupancy Video Component. This can be flagged in the V3C bitstream by signaling that this process is used by setting the flag base_mesh_attribute_data_packed_in_geometry_flag to true. The base mesh attribute data can be encoded in RAW patches for example or by flagging geometry and attribute presence per pin_region_tile inside the same atlas.

### Encoding Embodiments

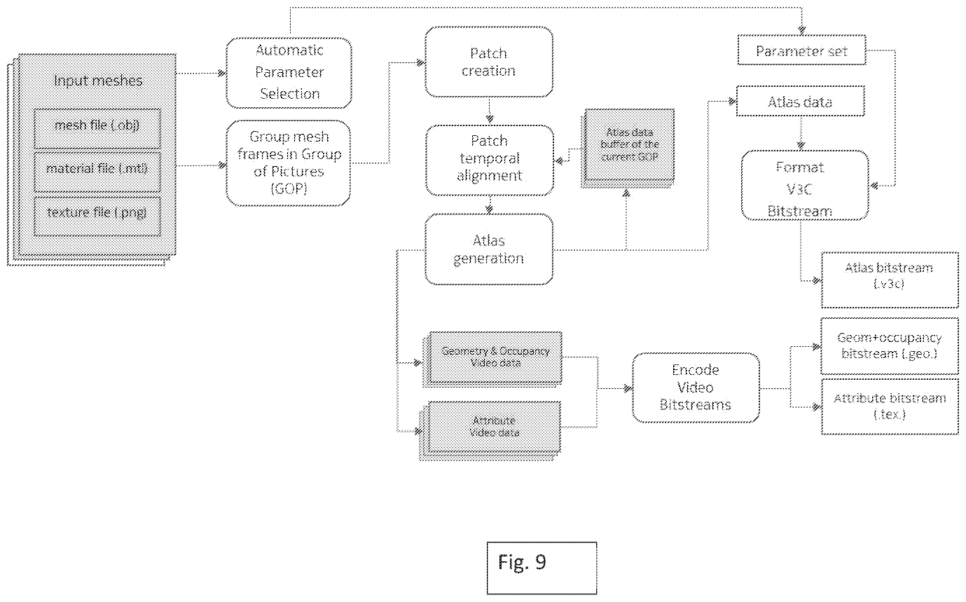

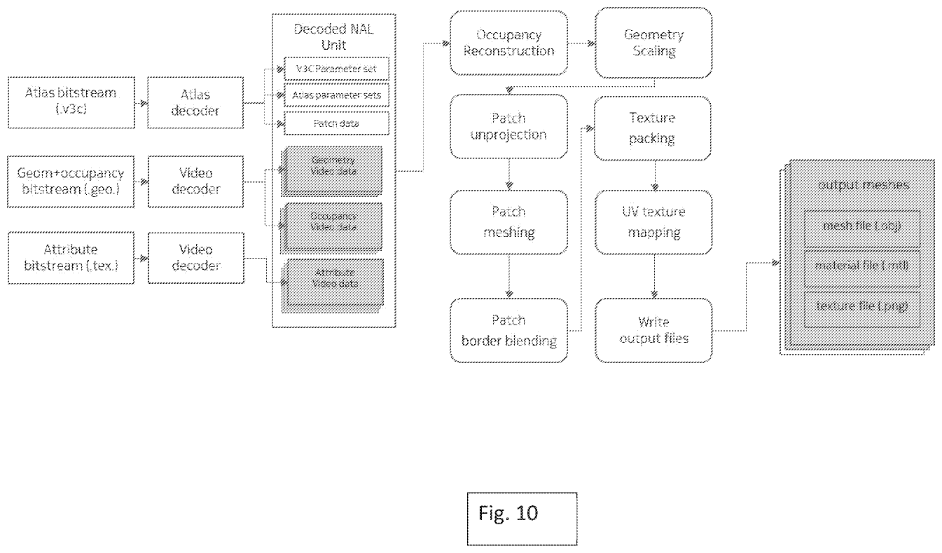

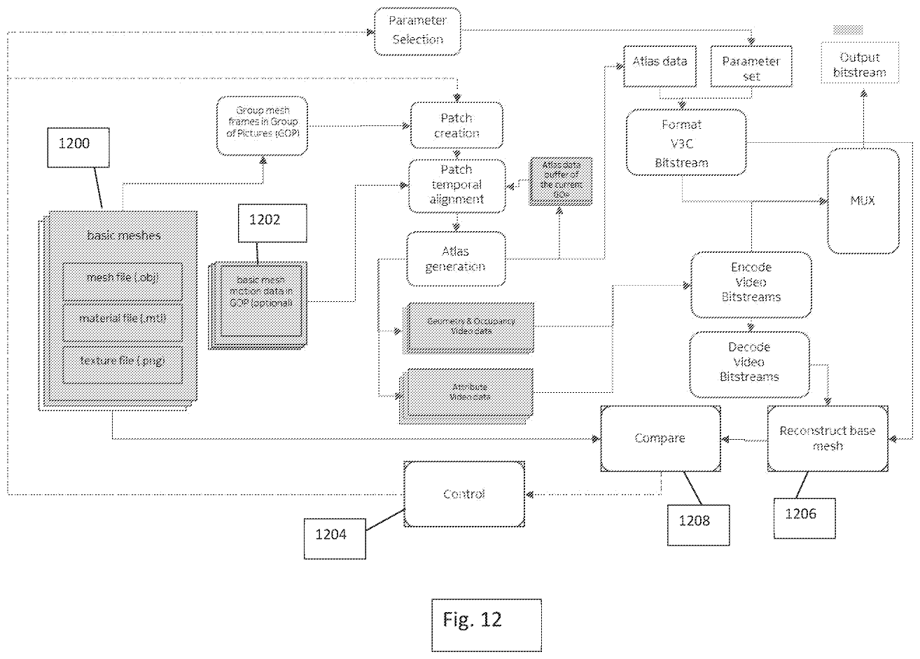

Reference is made to FIGS. 9 and 10 in regard to the encoding of Geometry and Occupancy for the base mesh. FIG. 9 is shown in regard to an encoder applied to the base mesh data and FIG. 10 is shown in regard to a decoder applied to the base mesh data. The encoder and decoder shown in FIGS. 9 and 10 may be applied to the base mesh. The encoder and decoder shown in FIGS. 9 and 10 can be the same as those shown in [Ron22]. FIGS. 12-14, further described below, show new additional features.

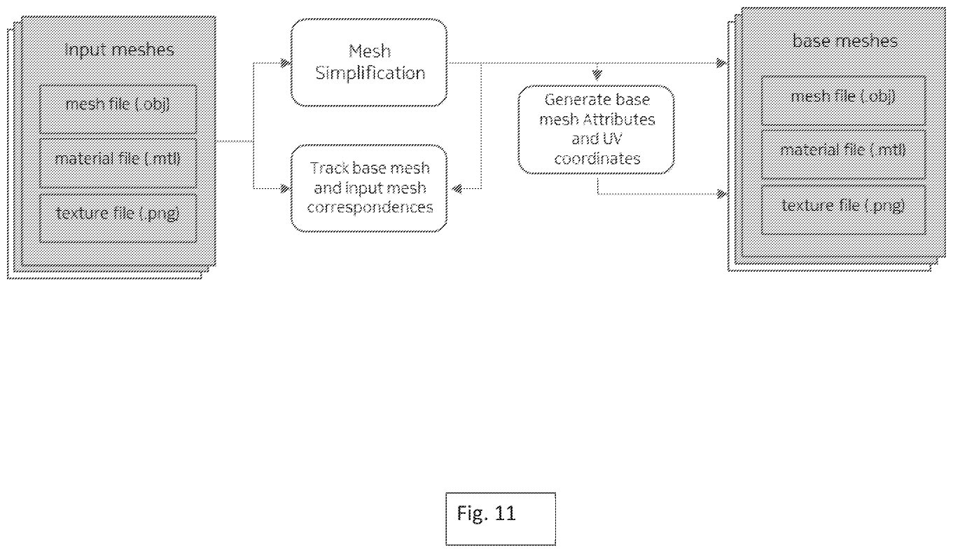

The generation of the base mesh is based on mesh simplification, where any algorithm can be used such as for example the recursive edge-collapse operations minimizing quadric error metrics on both geometry and attribute data as illustrated on FIG. 11. FIG. 11 is shown in regard to Base Mesh generation. Other simplification algorithms may be used such as progressive meshes approaches that take Attribute data into account. In the simplification process, the correspondences between vertices of the output base mesh and of the original input mesh may be kept in order to generate the base mesh UV coordinates. This generation is performed by filtering UV coordinates (such as averaging for example) of the set of input mesh vertices that map to the same base mesh vertex.

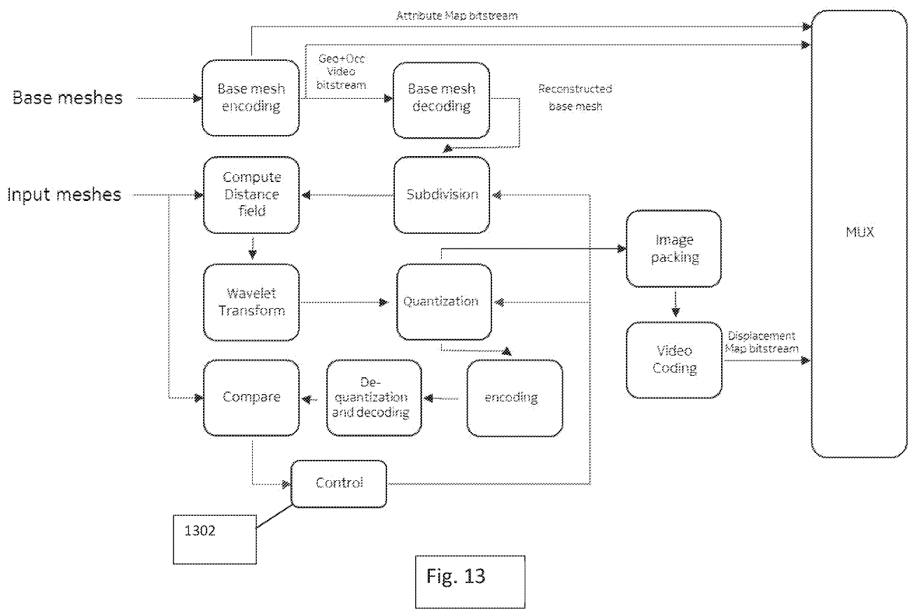

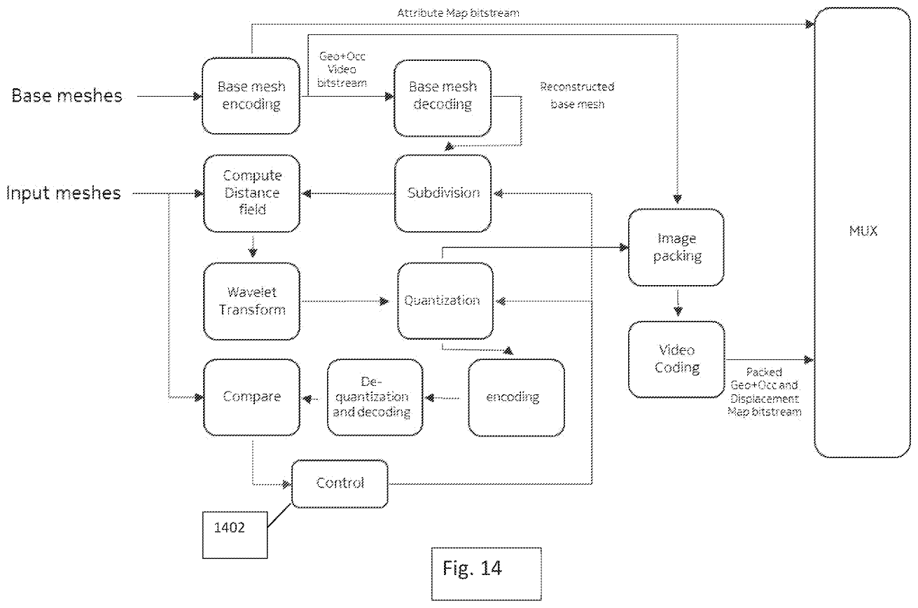

In Random Access use cases, within a Group of Pictures (GOP), a reference base mesh for one frame can be selected, for example the first one in the GOP, but it can be any other one, and use this same reference base mesh for all other frames. As motion can occur within a GOP, the reference base mesh may be deformed between the corresponding input mesh reference frame and other frames in the GOP. This motion information may be used by the encoder to align patches temporally in the patch packing module represented on FIG. 12. FIG. 12 is shown in regard to encoding of base meshes. As seen in FIG. 12, basic meshes 1200, such as a mesh file, a material file, and a texture file, may be provided. Optionally, there may be a base mesh motion data in GOP, as indicated by block 1202, which may be provided to the patch temporal alignment. The basic meshes 1200 may be provided for group mesh frames in GOP, and also to a control feature 1204. The basic meshes 1200 may also be provided to a comparison feature 1208. The comparison feature 1208 is configured to compare the basic meshes 1200 to an output from the reconstruct base mesh feature 1208, where the reconstruct base mesh feature 1206 receives input from the decode video bitstreams feature and the format v3c bitstream feature. Output from the control feature 1204 may be provided to both the parameter selection feature and the patch creation feature. Thus, the base meshes may be encoded as shown in FIG. 12 and, subsequently, then with features such as what is shown in the example embodiments on FIGS. 13 and 14 for both the base meshes and the input meshes. This may include wavelet transform and quantization for example as shown in FIGS. 13 and 14.

Moreover, the base mesh encoder may contain a Control module that orchestrates the encoding process. After a first iteration, output Video Components may be encoded using the target video coding parameters (e.g., QPs, GOP size etc), decoded and the base mesh may be reconstructed. The reconstructed base mesh may be optionally compared with the original and patches that caused distortions (holes, low quality geometry etc) may be detected and the control module may modify such patches by splitting or merging these patches. This process may be iterated until an acceptable quality is reached in the comparison module.

FIGS. 13 and 14 illustrate the full encoding process for the three and two vido components embodiments respectively. FIG. 13 is shown in regard to the full mesh encoding process corresponding to a three video components embodiment. FIG. 14 is shown in regard to a full mesh encoder with geometry, occupancy and displacement field packing. As can be seen in FIG. 13, a control feature 1302 is provided which receives input from the compare feature, and provides output to both the subdivision feature and the quantization feature. Likewise, as can be seen in FIG. 14, a control feature 1402 is provided which receives input from the compare feature, and provides output to both the subdivision feature and the quantization feature.

In a three video components case, the encoder may first encode a base mesh frame and generate a Geometry+Occupancy video component that is coded into a bitstream through video encoding. This feature provides for quality of the output and is different than a conventional system, such as that uses Draco to encode the mesh in a near-lossless mode for example. Using purely-video encoding, the base mesh geometry may be less accurately reconstructed than with a mesh codec such as Draco. However, using a decoded and reconstructed version of the base mesh to compute the subdivision and wavelets, the proposed approach compensates for this loss of accuracy. Indeed, at the full mesh decoder side, the same values from the reconstructed base mesh may be used, as in the full mesh encoder, to compute predictions and displacements. This bitstream may be decoded and the base mesh reconstructed to serve as basis for the hierarchical construction in order to reduce possible drift between encoder and decoder. The reconstructed base mesh may be the input of the subdivision module that splits base mesh faces into four faces by using mid-point subdivision for example (other subdivision schemes can be used). A control module may set the maximal level of subdivisions to be performed. Distance field vectors may be computed using the subdivided base mesh and the input mesh. These distance field vectors may be sent to a wavelet transform module that generates wavelet coefficients that are quantized and coded. This representation may then be decoded and de-quantized to be compared with the input mesh frame into the compare module. The Control module may add a subdivision level if the comparison metric is smaller than a pre-defined threshold. The quantized wavelet coefficients may be packed into a Video Component that is encoded through a video coding module. The output bitstream may be muxed with the base mesh Geo+Occ bitstream and Attribute Map bitstream as well as the V3C bitstream. A wavelet encoded may comprise the case where the wavelet transform is the identity transform.

In the case of two video components, the encoder illustrated on FIG. 14 may pack the Geometry and Occupancy data and the displacement field data in a single Video Component. This can be performed with tiles and V3C signaling of pin_region_tiles as explained before and detailed further later in this document. An additional feature provided by packing this data into a single video component is that it eases synchronization at the decoder side; since a single hardware decoding instance may be used for all geometry reconstruction related data.

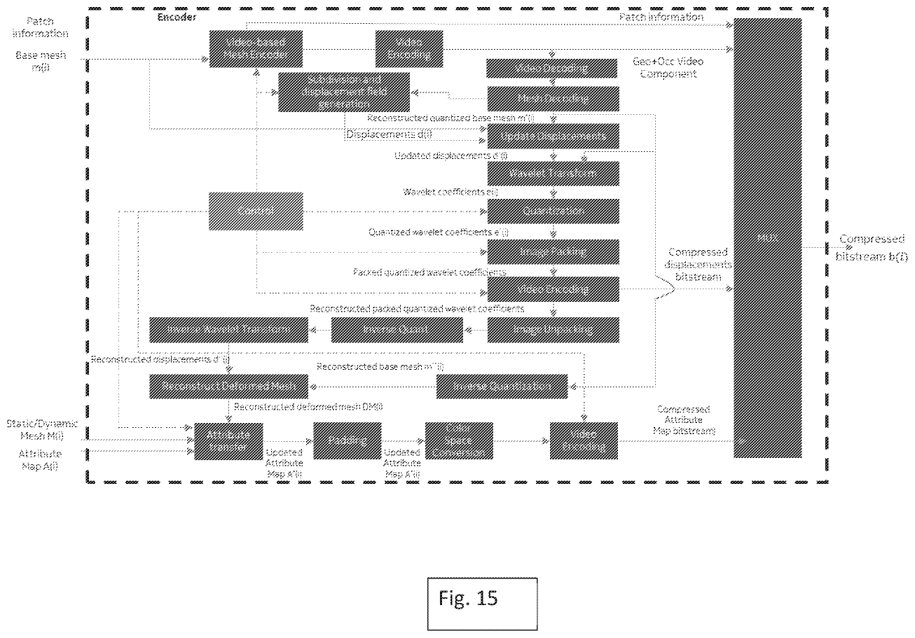

These encoding schemes can be easily extended to also compute the Attribute Map after wavelet transform and displacement field encoding as in [Mam22] rather than selecting the one computed in the base mesh encoding module as illustrated on FIG. 15. FIG. 15 is shown in regard to a mesh encoder with Attribute Map recomputed after wavelet transform.

The encoder may also generate Attribute Maps from the reconstructed deformed mesh, i.e., the mesh obtained by subdividing the reconstructed base mesh and displaced with decoded, unquantized displacement vectors as illustrated on FIG. 15. Unlike [Mam22], the base mesh may be purely video encoded, and the base mesh may also be video decoded in the full mesh encoder. The control module may tune compression parameters of the purely-video encoded base mesh with more granularity than with a mesh codec, such as Draco for example, while keeping reconstructed data for computing displacement fields. Subdivision and displacement field computation are similar to FIGS. 13 and 14. Instead of using the base mesh Attribute Map, the Full mesh Attribute Map may be recomputed and video encoded based on the full mesh resolution. This leads to higher bitrate than reusing the base mesh Attribute Map that has smaller resolution, but may increase quality, especially at high rates.

It should be noted that the process of subdividing the base mesh and generating displacement vectors can either be done at a pre-processing stage on raw data, and then updated in the encoder from reconstructed data or directly computed in the encoder from reconstructed data.

### V3C Signalling Embodiments

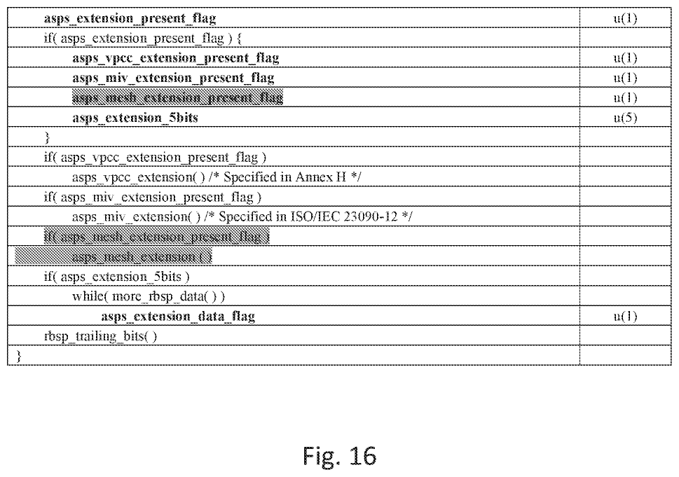

In one example embodiment, the presence of mesh encoding related metadata in the V3C bitstream is signalled with the flag asps_mesh_extension_present_flag as part of atlas sequence parameter set or atlas frame parameter set in a dedicated extension syntax. This may be seen with reference to FIG. 16. asps_mesh_extension_present_flag equal to 1 may specify that the asps_mesh_extension ( ) syntax structure is present in the atlas_sequence_parameter_set ( ) syntax structure. asps_mesh_extension_present_flag equal to 0 may specify that this syntax structure is not present.

Different example embodiments, such as described below, may be used for signaling that the v3c bitstream contains information describing both the base mesh and the full resolution mesh.

A first example embodiment may consist in creating different atlases for the base mesh and the displacement field information. This allows to create different patch layouts for the base mesh and the information required to reconstruct the full mesh. This is possible by setting appropriate values in the V3C_parameter_set (VPS), reserving for example two atlases, one for the base mesh and another one for the full mesh data respectively. The frame width and height of these atlases may be different.

### General V3C Parameter Set Syntax

| | Descriptor |
|---|---|
| v3c_parameter_set( numBytesInV3CPayload ) { | |
| profile_tier_level( ) | |
| vps_v3c_parameter_set_id | u(4) |
| vps_reserved_zero_8bits | u(8) |
| vps_atlas_count_minus1 | u(6) |
| for( k = 0; k < vps_atlas_count_minus1 + 1; k++ ) { | |
| vps_atlas_id[ k ] | u(6) |
| j = vps_atlas_id[ k ] | |
| vps_frame_width[ j ] | ue(v) |
| vps_frame_height[ j ] | ue(v) |
| vps_map_count_minus1 [ j ] | u(4) |
| if( vps_map_count_minus1 [ j ] > 0 ) | |
| vps_multiple_map_streams_present_flag[ j ] | u(1) |
| vps_map_absolute_coding_enabled_flag[ j ][ 0 ] = 1 | |
| vps_map_predictor_index_diff[ j ][ 0 ] = 0 | |
| for( i = 1; i <= vps_map_count_minus1 [ j ]; i++ ) { | |
| if( vps_multiple_map_streams_present_flag[ j ] ) | |
| vps_map_absolute_coding_enabled_flag[ j ][ i ] | u(1) |
| Else | |
| vps_map_absolute_coding_enabled_flag[ j ][ i ] = 1 | |
| if( vps_map_absolute_coding_enabled_flag[ j ][ i ] == 0 ) { | |
| vps_map_predictor_index_diff[ j ][ i ] | ue(v) |
| } | |
| } | |
| vps_auxiliary_video_present_flag[ j ] | u(1) |
| vps_occupancy_video_present_flag[ j ] | u(1) |
| vps_geometry_video_present_flag[ j ] | u(1) |
| vps_attribute_video_present_flag[ j ] | u(1) |
| if( vps_occupancy_video_present_flag[ j ] ) | |
| occupancy_information( j ) | |
| if( vps_geometry_video_present_flag[ j ] ) | |
| geometry_information( j ) | |
| if( vps_attribute_video_present_flag[ j ] ) | |
| attribute_information( j ) | |
| } | |
| vps_extension_present_flag | u(1) |
| if( vps_extension_present_flag ) { | |
| vps_packing_information_present_flag | u(1) |
| vps_miv_extension_present_flag | u(1) |
| vps_mesh_extension_present_flag | u(1) |
| vps_extension_6bits | u(6) |
| } | |
| if( vps_packing_information_present_flag ) { | |
| for( k = 0; k <= vps_atlas_count_minus1; k++ ) { | |
| j = vps_atlas_id[ k ] | |
| vps_packed_video_present_flag[ j ] | |
| if( vps_packed_video_present_flag[ j ] ) | |
| packing_information( j ) | |
| } | |
| } | |
| if( vps_miv_extension_present_flag ) | |
| vps_miv_extension( ) /*Specified in ISO/IEC 23090-121 */ | |
| if( asps_mesh_extension_present_flag ) | |
| vps_mesh_extension ( ) | |
| if( vps_extension_6bits ) { | |
| vps_extension_length_minus1 | ue(v) |
| for( j = 0; j < vps_extension_length_minus1 + 1; j++ ) { | |
| vps_extension_data_byte | u(8) |
| } | |
| } | |
| byte_alignment( ) | |
| } | |

asps-mesh_extension-present_flag equal to 1 specifies ______ that the asps_mesh_extension ( ) syntax structure is present in the atlas_sequence_parameter_set ( ) syntax structure. asps_mesh_extension_present_flag equal to 0 specifies that this syntax structure is not present.

| | Descriptor |
|---|---|
| vps_mesh_extension ( ) { | |
| vps_base_mesh_atlas_count_minus1 | u(6) |
| for( k = 0; k < vps_base_mesh_atlas_count_minus1 + 1; k++ ) { | |
| vps_base_mesh_atlas_id[ k ] | u(6) |
| vps_enhancement_data_atlas_count_minus1 | u(6) |
| for( k = 0; k < vps_enhancement_data_atlas_count_minus1 + 1; k++ ) { | |
| vps_enhancement_data_atlas_id[ k ] | u(6) |

vps_base_mesh_atlas_count_minus1 plus 1 indicates the total number of supported atlases in the current bitstream for representing the base mesh. The value of vps_base_mesh_atlas_count_minus1 shall be in the range of 0 to 31, inclusive.

vps_base_mesh_atlas_id[k] specifies the ID of the base mesh atlas with index k. The value of vps_base_mesh_atlas_id[k] shall be in the range of 0 to 31, inclusive. It is a requirement that vps_base_mesh_atlas_id[j] shall not be equal to vps_base_mesh_atlas_id[k] for all j!=k.

vps_enhancement_data_atlas_count_minus1 plus 1 indicates the total number of supported atlases in the current bitstream for representing the enhancement data. The value of vps_enhancement_data_atlas_count_minus1 shall be in the range of 0 to 31, inclusive.

vps_enhancement_data_atlas_id[k] specifies the ID of the base mesh atlas with index k. The value of vps_base_mesh_atlas_id[k] shall be in the range of 0 to 31, inclusive. It is a requirement that vps_enhancement_data_atlas_id[j] shall not be equal to vps_enhancement_data_atlas_id[k] for all j!=k. It is also a requirement that It is a requirement that vps_base_mesh_atlas_id[j] shall not be equal to vps_enhancement_data_atlas_id[k] for all j and k.

Alternatively, the base mesh and enhancement data can be mapped to dedicated layers (the base mesh being the first layer 0, then enhancement data corresponding to layer 1, with the possibility to add other layers), which have their own atlases as follows:

Descriptor

vps_mesh_extension ( ) {
layer_mapping ( )
}

| | Descriptor |
|---|---|
| layer_mapping ( ) { | |
| lm_layer_count | u(4) |
| if( lm_layer_count > 0) | |
| for( k = 0; k <= vps_atlas_count_minus1; k++ ) | |
| j = vps_atlas_id[ k ] | |
| lm_layer_id[ j ] | u(v) |
| } | |

lm_layer_count specifies the total number of supported layers in the current bitstream. The value of lm_layer_count shall be in the range of 0 to 15, inclusive.

lm_layer_id[k] specifies the ID of the layer for the atlas with ID equal to k. The number of bits used to represent lm_layer_id[k] is equal to Ceil(Log 2(lm_layer_count)).

Another embodiment signals that a base mesh and enhancement data are mapped to atlas sub-bitstreams, it follows that the same patch layout for the base mesh and enhancement layers must be used.

Yet another embodiment is based on separate V3C sub-bitstreams for the base mesh that is therefore considered as represented with the V3C “codec” as a separate and independent sub-stream.

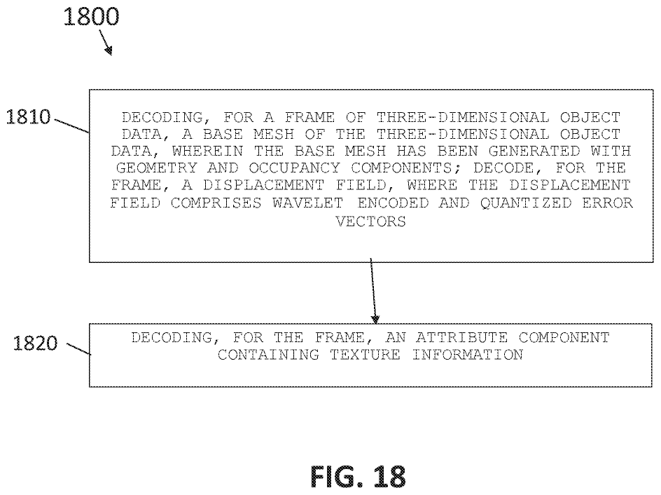

Referring also to FIG. 18, an example method 1800 may be provided comprising decoding as indicated by block 1810, for a frame of three-dimensional object data, a base mesh of the three-dimensional object data, wherein the base mesh has been generated with geometry and occupancy components; decode, for the frame, a displacement field, where the displacement field comprises wavelet encoded and quantized position displacements; and decoding as indicated by block 1820, for the frame, an attribute component containing texture information. In an embodiment, the geometry and occupancy components are packed together.

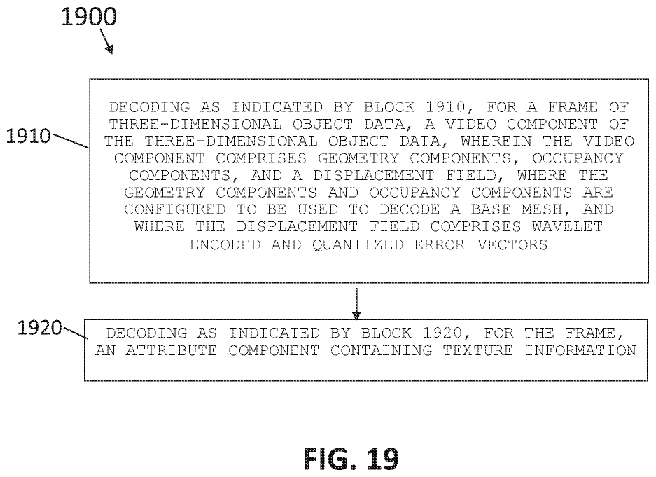

Referring also to FIG. 19, an example method 1900 may be provided comprising decoding as indicated by block 1910, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements; and decoding as indicated by block 1920, for the frame, an attribute component containing texture information. In an embodiment, geometry components, occupancy components, and a displacement field are packed together.

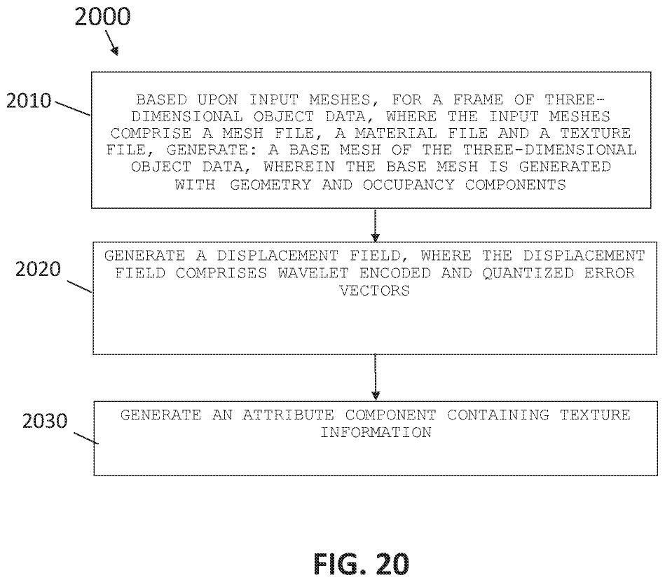

Referring also to FIG. 20, an example method 2000 may be provided comprising as indicated by block 2010, based upon input meshes, for a frame of three-dimensional object data, where the input meshes comprise a mesh file, a material file and a texture file, generate: a base mesh of the three-dimensional object data, wherein the base mesh is generated with geometry and occupancy components; as indicated by block 2020 a displacement field, where the displacement field comprises wavelet encoded and quantized position displacements; and as indicated by block 2030 an attribute component containing texture information. The input meshes may comprise, optionally, the material file and a texture file. The meshes may be encoded with no texture, or meshes that have color data but no texture data for example. In an embodiment, the geometry and occupancy components are packed together.

An example apparatus may be provided comprising: at least one processor; and at least one memory including computer program code; wherein the at least one memory and the computer program code are configured to, with the at least one processor, cause the apparatus at least to: decode, for a frame of three-dimensional object data, a base mesh of the three-dimensional object data, wherein the base mesh has been generated with a geometry component; decode, for the frame, a displacement field, where the displacement field comprises wavelet encoded and quantized position displacements.

The apparatus may be configured to decode, for the frame, an attribute component containing texture information. The base mesh may have been generated with the geometry and occupancy components. The wavelet encoded and quantized position displacements may comprise where a wavelet transform is an identity transform. In an embodiment, the geometry and occupancy components are packed together.

An example method may be provided comprising: decoding, for a frame of three-dimensional object data, a base mesh of the three-dimensional object data, wherein the base mesh has been generated with a geometry component; decoding, for the frame, a displacement field, where the displacement field comprises wavelet encoded and quantized position displacements.

The method may further comprise decoding, for the frame, an attribute component containing texture information. The base mesh may have been generated with the geometry and occupancy components. The wavelet encoded and quantized position displacements may comprise where a wavelet transform is an identity transform. In an embodiment, the geometry and occupancy components are packed together.

An example embodiment may be provided with a non-transitory program storage device readable by a machine, tangibly embodying a program of instructions executable by the machine for performing operations, the operations comprising: decoding, for a frame of three-dimensional object data, a base mesh of the three-dimensional object data, wherein the base mesh has been generated with a geometry component; decoding, for the frame, a displacement field, where the displacement field comprises wavelet encoded and quantized position displacements.

An example embodiment may be provided with an apparatus comprising: means for decoding, for a frame of three-dimensional object data, a base mesh of the three-dimensional object data, wherein the base mesh has been generated with a geometry component; means for decoding, for the frame, a displacement field, where the displacement field comprises wavelet encoded and quantized position displacements.

An example embodiment may be provided with an apparatus comprising: at least one processor; and at least one memory including computer program code; wherein the at least one memory and the computer program code are configured to, with the at least one processor, cause the apparatus at least to: decode, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. The apparatus may be configured to decode, for the frame, an attribute component containing texture information. In an embodiment, the geometry components, occupancy components, and a displacement field are packed together.

An example method may be provided comprising: decoding, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. The method may further comprise decoding, for the frame, an attribute component containing texture information. In an embodiment, the geometry components, occupancy components, and a displacement field are packed together.

An example embodiment may be provided with a non-transitory program storage device readable by a machine, tangibly embodying a program of instructions executable by the machine for performing operations, the operations comprising: decoding, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. In an embodiment, the geometry components, occupancy components, and a displacement field are packed together.

An example embodiment may be provided with an apparatus comprising: means for decoding, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. The apparatus may further comprise means for decoding, for the frame, an attribute component containing texture information. In an embodiment, the geometry components, occupancy components, and a displacement field are packed together.

An example embodiment may be provided with an apparatus comprising: at least one processor; and at least one memory including computer program code; wherein the at least one memory and the computer program code are configured to, with the at least one processor, cause the apparatus at least to: based upon input meshes, for a frame of three-dimensional object data, where the input meshes comprise a mesh file and a material file, generate: a base mesh of the three-dimensional object data, wherein the base mesh is generated with geometry and occupancy components; a displacement field, where the displacement field comprises wavelet encoded and quantized position displacements. The apparatus may be configured to generate, based upon the input meshes, an attribute component containing texture information. The input meshes may comprise a texture file. In an embodiment, the geometry and occupancy components are packed together.

An example method may be provided comprising: based upon input meshes, for a frame of three-dimensional object data, where the input meshes comprise a mesh file and a material file, generating: a base mesh of the three-dimensional object data, wherein the base mesh is generated with geometry and occupancy components; a displacement field, where the displacement field comprises wavelet encoded and quantized position displacements. The generating may comprise, based upon the input meshes, generating an attribute component containing texture information. The input meshes may comprise a texture file. In an embodiment, the geometry occupancy components are packed together.

An example embodiment may be provided with a non-transitory program storage device readable by a machine, tangibly embodying a program of instructions executable by the machine for performing operations, the operations comprising: based upon input meshes, for a frame of three-dimensional object data, where the input meshes comprise a mesh file and a material file, generating: a base mesh of the three-dimensional object data, wherein the base mesh is generated with geometry and occupancy components; a displacement field, where the displacement field comprises wavelet encoded and quantized position displacements. In an embodiment, the geometry and occupancy components are packed together.

An example embodiment may be provided with an apparatus comprising: means for, based upon input meshes, for a frame of three-dimensional object data, where the input meshes comprise a mesh file and a material file, generating: a base mesh of the three-dimensional object data, wherein the base mesh is generated with geometry and occupancy components; a displacement field, where the displacement field comprises wavelet encoded and quantized position displacements. In an embodiment, the geometry and occupancy components are packed together.

An example embodiment may be provided with an apparatus comprising: at least one processor; and at least one memory including computer program code; wherein the at least one memory and the computer program code are configured to, with the at least one processor, cause the apparatus at least to: based upon input meshes, for a frame of three-dimensional object data, where the input meshes comprise a mesh file, a material file and a texture file, generate: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. The apparatus may be configured to generate, based upon the input meshes, for the frame, an attribute component containing texture information. In an embodiment, the geometry components, occupancy components, and a displacement field are packed together.

An example method may be provided comprising: based upon input meshes, for a frame of three-dimensional object data, where the input meshes comprise a mesh file, a material file and a texture file, generating: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. The generating may further comprise generating, based upon the input meshes, for the frame, an attribute component containing texture information. In an embodiment, the geometry components, occupancy components, and a displacement field are packed together.

An example embodiment may be provided with a non-transitory program storage device readable by a machine, tangibly embodying a program of instructions executable by the machine for performing operations, the operations comprising: based upon input meshes, for a frame of three-dimensional object data, where the input meshes comprise a mesh file, a material file and a texture file, generating: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. In an embodiment, the geometry components, occupancy components, and a displacement field are packed together.

An example embodiment may be provided with an apparatus comprising: Means for, based upon input meshes, for a frame of three-dimensional object data, where the input meshes comprise a mesh file, a material file and a texture file, generating: for the frame, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements. In an embodiment, the geometry components, occupancy components, and a displacement field are packed together.

An example embodiment may be provided with an apparatus comprising: at least one processor; and at least one memory including computer program code; wherein the at least one memory and the computer program code are configured to, with the at least one processor, cause the apparatus at least to: signal within a bitstream a flag indicating the presence of a mesh encoding relating to metadata of three-dimensional object data, where the flag is configured to signal geometry and occupancy data and displacement field data in a single video component.

An example method may be provided comprising: signaling within a bitstream a flag indicating the presence of a mesh encoding relating to metadata of three-dimensional object data, where the flag is configured to signal geometry and occupancy data and displacement field data in a single video component.

An example embodiment may be provided with a non-transitory program storage device readable by a machine, tangibly embodying a program of instructions executable by the machine for performing operations, the operations comprising: signaling within a bitstream a flag indicating the presence of a mesh encoding relating to metadata of three-dimensional object data, where the flag is configured to signal geometry and occupancy data and displacement field data in a single video component.

An example embodiment may be provided with an apparatus comprising: means for signaling within a bitstream a flag indicating the presence of a mesh encoding relating to metadata of three-dimensional object data, where the flag is configured to signal geometry and occupancy data and displacement field data in a single video component.

An example apparatus may be provided comprising: at least one processor; and at least one memory including computer program code; wherein the at least one memory and the computer program code are configured to, with the at least one processor, cause the apparatus at least to: decode, for a frame of three-dimensional object data, a base mesh of the three-dimensional object data, wherein the base mesh has been generated with geometry and occupancy components; decode, for the frame, a displacement field, where the displacement field comprises wavelet encoded and quantized position displacements; and decode, for the frame, an attribute component containing texture information. In an embodiment, the geometry and occupancy components are packed together.

An example apparatus may be provided comprising: at least one processor; and at least one memory including computer program code; wherein the at least one memory and the computer program code are configured to, with the at least one processor, cause the apparatus at least to: decode, for a frame of three-dimensional object data, a video component of the three-dimensional object data, wherein the video component comprises geometry components, occupancy components, and a displacement field, where the geometry components and occupancy components are configured to be used to decode a base mesh, and where the displacement field comprises wavelet encoded and quantized position displacements; and decode, for the frame, an attribute component containing texture information. In an embodiment, the geometry components, occupancy components, and a displacement field are packed together.

An example apparatus may be provided comprising: at least one processor; and at least one memory including computer program code; wherein the at least one memory and the computer program code are configured to, with the at least one processor, cause the apparatus at least to: based upon input meshes, for a frame of three-dimensional object data, where the input meshes comprise a mesh file, a material file and a texture file, generate: a base mesh of the three-dimensional object data, wherein the base mesh is generated with geometry and occupancy components; a displacement field, where the displacement field comprises wavelet encoded and quantized position displacements; and an attribute component containing texture information. The input meshes may comprise, optionally, the material file and a texture file. The meshes may be encoded with no texture, or meshes that have color data but no texture data for example. In an embodiment, the geometry and occupancy components are packed together.

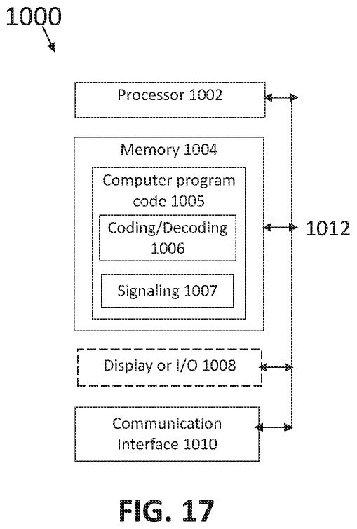

FIG. 17 is an apparatus 1000 which may be implemented in hardware, configured to implement compression of mesh geometry based on 3D patch contours, based on any of the examples described herein. The apparatus comprises a processor 1002, at least one memory 1004 (memory 1004 may be non-transitory, transitory, non-volatile, or volatile) including computer program code 1005, wherein the at least one memory 1004 and the computer program code 1005 are configured to, with the at least one processor 1002, cause the apparatus to implement circuitry, a process, component, module, function, coding, and/or decoding (collectively 1006) to implement compression of mesh geometry based on 3D patch contours, based on the examples described herein. The apparatus 1000 is further configured to provide or receive signaling 1007, based on the signaling embodiments described herein. The apparatus 1000 optionally includes a display and/or I/O interface 1008 that may be used to display an output (e.g., an image or volumetric video) of a result of coding/decoding 1006. The display and/or I/O interface 1008 may also be configured to receive input such as user input (e.g. with a keypad, touchscreen, touch area, microphone, biometric recognition etc.). The apparatus 1000 also includes one or more communication interfaces (I/F(s)) 1010, such as a network (NW) interface. The communication I/F(s) 1010 may be wired and/or wireless and facilitate communication over a channel or the Internet/other network(s) via any communication technique. The communication I/F(s) 1010 may comprise one or more transmitters and one or more receivers. The communication I/F(s) 1010 may comprise standard well-known components such as an amplifier, filter, frequency-converter, (de)modulator, and encoder/decoder circuitry(ies) and one or more antennas. In some examples, the processor 1002 is configured to implement item 1006 and/or item 1007 without use of memory 1004.

The apparatus 1000 may be a remote, virtual or cloud apparatus. The apparatus 1000 may be either a writer or a reader (e.g. parser), or both a writer and a reader (e.g. parser). The apparatus 1000 may be either a coder or a decoder, or both a coder and a decoder (codec). The apparatus 1000 may be a user equipment (UE), a head mounted display (HMD), or any other fixed or mobile device.

The memory 1004 may be implemented using any suitable data storage technology, such as semiconductor based memory devices, flash memory, magnetic memory devices and systems, optical memory devices and systems, fixed memory and removable memory. The memory 1004 may comprise a database for storing data. Interface 1012 enables data communication between the various items of apparatus 1000, as shown in FIG. 17. Interface 1012 may be one or more buses. For example, the interface 1012 may be one or more buses such as address, data, or control buses, and may include any interconnection mechanism, such as a series of lines on a motherboard or integrated circuit, fiber optics or other optical communication equipment, and the like. Interface 1012 may be one or more software interfaces configured to pass data within computer program code 1005. For example, interface 1012 may comprises an object-oriented software interface. The apparatus 1000 need not comprise each of the features mentioned, or may comprise other features as well. The apparatus 1000 may be an embodiment of and have the features of any of the apparatuses shown in any of the figures described above including, for example, FIG. 1A, FIG. 1B, FIG. 5, and/or FIG. 6.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry may also be used to mean a function or a process, such as one implemented by an encoder or decoder, or a codec.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:

| | |
|---|---|
| 2D or 2d | two-dimensional |
| 3D or 3d | three-dimensional |
| 3DG | 3D graphics coding group |
| 6DOF | six degrees of freedom |
| ACL | atlas coding layer |
| AR | augmented reality |
| ASIC | application-specific integrated circuit |
| asps | atlas sequence parameter set |
| CfP | call for proposal (s) |
| CGI | computer-generated imagery |
| FDIS | final draft international standard |
| GEO | geometry data of mesh |
| glTF | graphics language transmission format |
| H.264 | advanced video coding video compression standard |
| H.265 | high efficiency video coding video compression |
| | standard |
| HMD | head mounted display |
| id | identifier |
| Idx | index |
| IEC | International Electrotechnical Commission |
| I/F | interface |
| I/O | input/output |
| ISO | International Organization for Standardization |
| miv or MIV | MPEG immersive video |
| MPEG | moving picture experts group |
| MPEG-I | MPEG immersive |
| MR | mixed reality |
| NAL or nal | network abstraction layer |
| NW | network |
| RBSP | raw byte sequence payload |
| SC | subcommittee |
| TEX | texture data of mesh |
| u (n) | unsigned integer using n bits, e.g. u (1) , u (2) |
| UE | user equipment |
| ue (v) | unsigned integer exponential Golomb coded syntax |
| | element with the left bit first |
| UV | coordinate texture, where “U” and “V” are axes of |
| | a 2D texture |
| V3C | visual volumetric video-based coding |
| VPCC or V-PCC | video-based point cloud |
| | coding/compression |
| VPS | V3C parameter set |
| VR | virtual reality |
| WG | working group |

1-35. (canceled)

36. An apparatus comprising:
at least one processor; and
at least one memory including computer program code;
wherein the at least one memory and the computer program code are configured to, with the at least one processor, cause the apparatus at least to:
decode, for a frame of three-dimensional object data, a base mesh of the three-dimensional object data, wherein the base mesh has been generated with a geometry component; and
decode, for the frame, a displacement field, where the displacement field comprises wavelet encoded and/or quantized position displacements.

37. The apparatus as claimed in claim 36 where the at least one memory and the computer program code are configured to, with the at least one processor, cause the apparatus at least to decode, for the frame, an attribute component comprising texture information.

38. The apparatus as claimed in claim 36 where the at least one memory and the computer program code are configured to, with the at least one processor, cause the apparatus at least to decode the base mesh where the base mesh has been generated further with occupancy component.

39. The apparatus as claimed in claim 36 where the wavelet encoded and/or quantized position displacements comprise where a wavelet transform is an identity or none transform.

40. The apparatus as claimed in claim 36, wherein the base mesh of the three-dimensional object data and the displacement field has been generated based upon input meshes for a frame of the three-dimensional object data, and wherein the input meshes comprise a mesh file and a material file.

41. A method comprising:
decoding, for a frame of three-dimensional object data, a base mesh of the three-dimensional object data, wherein the base mesh has been generated with a geometry component; and
decoding, for the frame, a displacement field, where the displacement field comprises wavelet encoded and/or quantized position displacements.

42. The method as claimed in claim 41 further comprising decoding, for the frame, an attribute component comprising texture information.

43. The method as claimed in claim 41 where the base mesh has been generated further with occupancy component.

44. The method as claimed in claim 41 where the wavelet encoded and/or quantized position displacements comprise where a wavelet transform is an identity or none transform.

45. The method as claimed in claim 41 where the base mesh of the three-dimensional object data and the displacement field has been generated based upon input meshes for a frame of the three-dimensional object data, and wherein the input meshes comprise a mesh file and a material file.

46. An apparatus comprising:
at least one processor; and
at least one memory including computer program code;
wherein the at least one memory and the computer program code are configured to, with the at least one processor, cause the apparatus at least to:
generate a base mesh of the three-dimensional object data, wherein the base mesh is generated with geometry component; and
generate a displacement field, where the displacement field comprises wavelet encoded and/or quantized position displacements.

47. The apparatus as claimed in claim 46 where the at least one memory and the computer program code are configured to, with the at least one processor, cause the apparatus at least to generate, based upon input meshes, an attribute component comprising texture information.

48. The apparatus as claimed in claim 46 where the base mesh is generated further with an occupancy component.

49. The apparatus as claimed in claim 46 where the wavelet encoded and/or quantized position displacements comprise where a wavelet transform is an identity or one transform.

50. The apparatus as claimed in claim 46, wherein the base mesh of the three-dimensional object data and the displacement field are generated based upon input meshes for a frame of the three-dimensional object data, and wherein the input meshes comprise a mesh file and a material file.

51. A method comprising:
generating a base mesh of the three-dimensional object data, wherein the base mesh is generated with geometry component; and
generating a displacement field, where the displacement field comprises wavelet encoded and/or quantized position displacements.

52. The method as claimed in claim 51 where the generating comprises, based upon input meshes, generating an attribute component comprising texture information.

53. The method as claimed in claim 51, where the base mesh is generated further with an occupancy component.

54. The method as claimed in claim 51 where the wavelet encoded and/or quantized position displacements comprise where a wavelet transform is an identity or none transform.

55. The method as claimed in claim 51, wherein the base mesh of the three-dimensional object data and the displacement field are generated based upon input meshes for a frame of the three-dimensional object data, and wherein the input meshes comprise a mesh file and a material file.
